(19) United States
(12) Patent Application Publication
(10) Pub. No.: US 2002/0193131 A1
(43) Pub. Date: Dec. 19, 2002

(54) Mobile wireless management of servers and other resources

(75) Inventors: Akimasa Fleshler, Portland, OR (US); Venkata R. Jagana, Portland, OR (US)

Correspondence Address: IBM CORPORATION, IP LAW DEPT, ED02-905, 15450 SW KOLL PARKWAY, BEAVERTON, OR, 97006-6063, US

(73) Assignee: International Business Machines Corporation, Armonk, NY

(21) Appl. No.: 09/884,596

(22) Filed: Jun. 18, 2001

(51) Int. Cl. H04B 7/00

(52) U.S. Cl. 455/507; 455/508; 709/219

(57) ABSTRACT

Mobile wireless management of servers and other resources is disclosed. A system is disclosed that includes a resource, such as a server or a network platform, and one or more mobile wireless consoles. Each mobile wireless console at least indirectly communicates with the resource over a wireless network, in accordance with an open, common, and non-proprietary protocol, to manage the resource. The system may include an intervening wireless gateway between the mobile wireless consoles and the resource, where the gateway may be located outside of a firewall. The open, common, and non-proprietary protocol may be a version of the Wireless Access Protocol (WAP), an Internet Protocol (IP)-based mobile protocol, or another type of protocol.

### BACKGROUND OF THE INVENTION

1. Technical Field

This invention relates generally to management of a resource, such as a server or a network platform, and more particularly to such management using a mobile wireless console, such as a wireless phone or a personal-digital-assistant (PDA) device having mobile wireless capability.

2. Description of the Prior Art

A server is a computer in a network shared by multiple users, and usually refers to both the hardware and the software that perform services for the users. Servers have become an important part in the computing architecture for organizations, both large and small, and have only increased in importance with the advent of the Internet. Servers may host database programs and other business applications, and store critical business and other types of data. On the Internet, most communication from end users is conducted with servers hosting web sites.

Therefore, servers should be very reliable and available. Desirably, they run twenty-four hours a day, seven days a week with minimal downtime. To ensure this, computer administrators should be able to efficiently manage the servers. Server management can include pre-boot activities, such as the initial configuration of a server, and in-band activities, which are activities after the server is running. In-band activities may include adding a user, modifying an existing network configuration, and other activities.

Administrators today perform most server management activities through a console that communicates with a server over a wired network. For example, the console may be a client computer on the same local-area network (LAN) on which the server resides. In this case, administration of the server can only occur when an administrator is physically located in the same premises in which the LAN is located. If an error occurs when the administrator is away from the LAN, he or she may have to immediately travel back to the premises to fix the problem.

A limited solution to this problem is remote administration of the server over the Internet that still requires a full console, such as a relatively powerful desktop or laptop computer. If an error occurs that requires the administrator's immediate attention, he or she may be able to fix the problem from a home computer connected to the Internet, or in a hotel using a laptop computer connected to the Internet. However, if the administrator is contacted with a server error while he or she is at a restaurant, at the movies, or at another place where Internet connectivity with a full console is usually impossible to obtain, then travel is still required by the administrator to fix the problem.

For mission-critical servers that must be available nearly 100% of the time, this means that there must always be an administrator on-site with the servers, or on-call and close to a full console. Besides being inconvenient to the administrator, this solution may also be costly for the organization, which may have to hire a number of administrators to ensure that one is always available, and may have to pay overtime for the administrators to be available at all times. For these described reasons, as well as other reasons, there is a need for the present invention.

### SUMMARY OF THE INVENTION

The invention relates to mobile wireless management of resources. A system of the invention includes a resource and one or more mobile wireless consoles. Each mobile wireless console at least indirectly communicates with the server over a wireless network, in accordance with an open, common, and non-proprietary protocol, to manage the resource.

A method of the invention receives a message including a resource management operation intended for a resource at a mobile wireless console. The mobile wireless console encodes the message in accordance with an open, common, and non-proprietary protocol. The message is sent as encoded from the mobile wireless console for ultimate delivery to the resource for performance of the operation over a wireless network, in accordance with the open, common, and non-proprietary protocol.

An article of manufacture of the invention includes a computer-readable signal-bearing medium, and means in the medium. The means is for managing a resource by at least indirectly communicating wirelessly with the resource over a wireless network. The communication is in accordance with an open, common, and non-proprietary protocol.

Other features and advantages of the invention will become apparent from the following detailed description of the presently preferred embodiment of the invention, taken in conjunction with the accompanying drawings.

### BRIEF DESCRIPTION OF THE DRAWINGS

FIG. 1 is a diagram of a system according to a preferred embodiment of the invention, and is suggested for printing on the first page of the issued patent.

FIG. 2 is a diagram of a system of a typical wireless gateway environment consistent with the Wireless Access Protocol (WAP), and in conjunction with which embodiments of the invention may be implemented.

FIG. 3 is a diagram of a typical WAP stack architecture, in conjunction with which embodiments of the invention may be implemented.

FIGS. 4, 5, and 6 are diagrams of examples of WAP stacks, in conjunction with which embodiments of the invention may be implemented.

FIG. 7 is a diagram of a system according to an embodiment of the invention in which a mobile wireless console communicates with a wireless gateway, which in turn communicates with a server through a firewall.

FIG. 8 is a diagram of a system according to another embodiment of the invention in which a mobile wireless console communicates with a wireless gateway, which in turn communicates with a server, but not through a firewall.

FIG. 9 is a diagram of a system according to another embodiment of the invention in which a mobile wireless console communicates directly with a server, without an intervening wireless gateway.

FIG. 10 is a flowchart of a method of an embodiment of the invention showing example communication among a mobile wireless console, a wireless gateway, and a server, and which may be performed in conjunction with either of the systems of FIGS. 7 and 8.

FIG. 11 is a flowchart of a method of another embodiment of the invention showing example communication between a mobile wireless console and a server, and which may be performed in conjunction with the system of FIG. 9.

### DESCRIPTION OF THE PREFERRED EMBODIMENT

### Overview

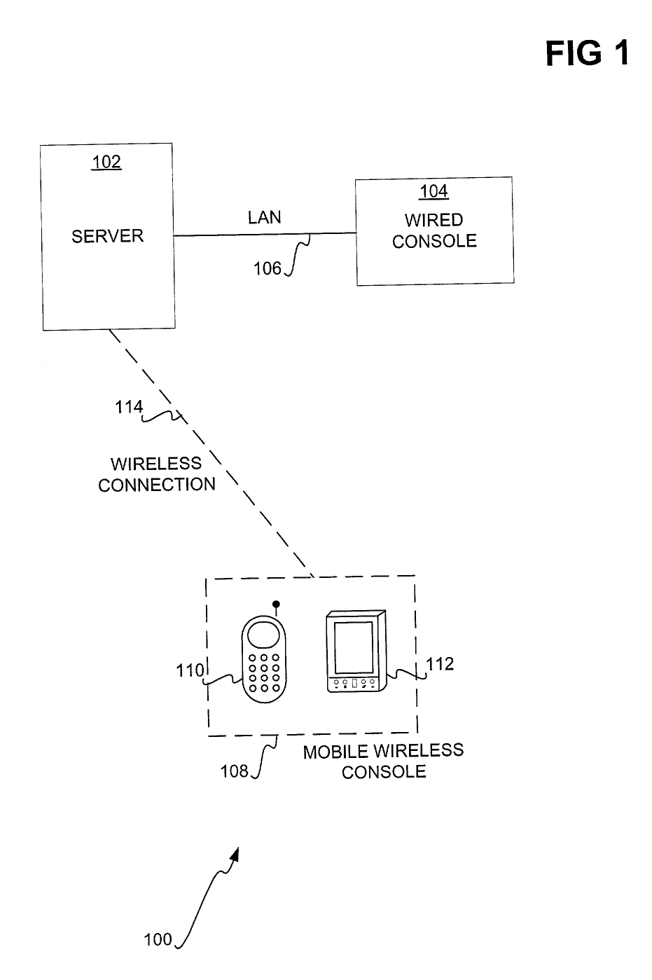

In the preferred embodiment of the invention, one or more mobile wireless consoles at least indirectly communicate wirelessly with a server over a wireless network, in accordance with an open, common, and non-proprietary protocol, to manage the server. FIG. 1 shows such a system 100 according to the preferred embodiment of the invention. A server 102 may be connected to a conventional wired console 104 through a local-area network (LAN) 106 so that the administrator may manage the server 102 when he or she is on-site. However, the administrator is also able to manage the server 102 using one of the mobile wireless consoles 108. As shown in FIG. 1, the mobile wireless consoles 108 include a wireless phone 110, such as a cellular phone, and a personal-digital-assistant (PDA) device 112 having mobile wireless communication capability. The mobile wireless consoles 108 maintain at least an indirect wireless connection 114 to the server 102.

The open, common, and non-proprietary protocol may be a version of the Wireless Access Protocol (WAP), which is maintained by the WAP Forum, Ltd., having an Internet web site at www.wapforum.org. The wireless connection 114 may be a direct wireless connection over a wireless network between the mobile wireless consoles 108 and the server 102. Alternatively, the wireless connection 114 may be an indirect wireless connection, in which the mobile wireless consoles 108 communicate over a wireless network with a wireless gateway (not shown in FIG. 1), which itself communicates over a wired network, such as the LAN 106, with the server 102. Such a wireless gateway may be located outside a firewall (also not shown in FIG. 1) that protects the server 102.

### Technical Background

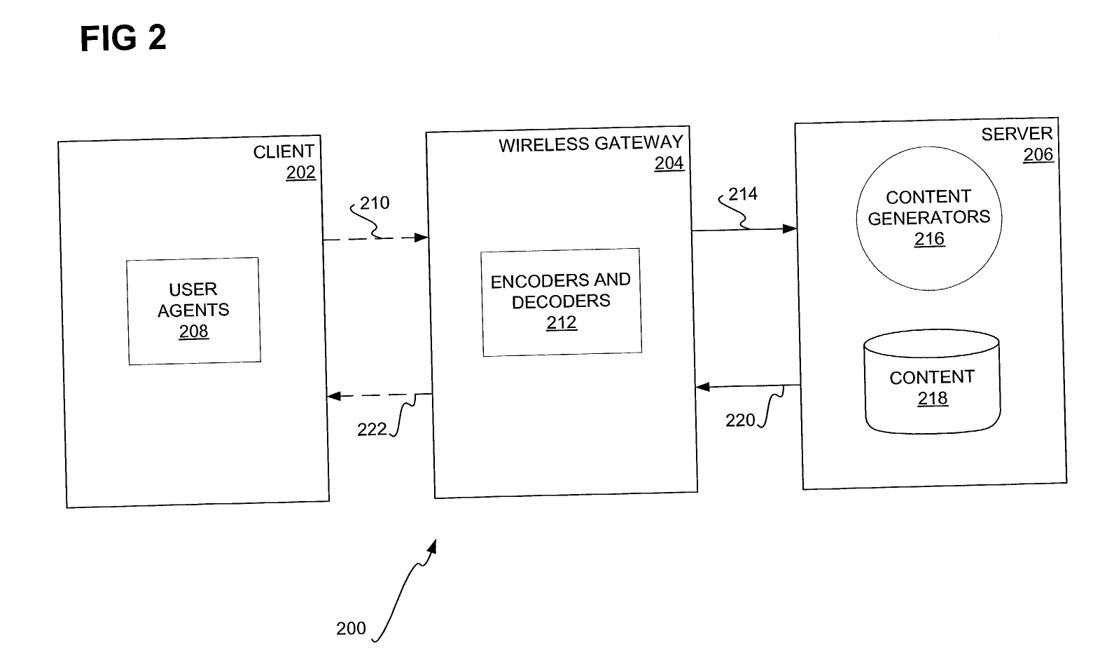

FIG. 2 shows a system 200 of a typical wireless gateway environment consistent with WAP, and in conjunction with which embodiments of the invention may be implemented. The system 200 includes a client 202, a wireless gateway 204, and a server 206. The server 206 is a type of resource that can be managed. Another resource that can be managed is a network platform. The client 202 may be a wireless phone, such as a cellular phone, a PDA device having wireless communication capability, or another type of client device. The client 202 has a number of user agents 208. The user agents 208 are client-side in-device software that provide specific functionality to the end user, such as to display content. The user agents 208, such as WAP browser programs, are integrated into the WAP architecture. They interpret network content referenced by a Universal Resource Locator (URL) address. A specific type of environment is the Wireless Application Environment (WAE), which includes user agents 208 for two primary standard contents: encoded Wireless Markup Language (WML), and compiled Wireless Markup Language Script (WMLScript).

A request initiated at the client 202 is encoded by the client 202, and sent over a wireless network to the wireless gateway 204, as indicated by the dotted line 210. The encoders and decoders 212 of the wireless gateway 204 decode the encoded request, and the decoded request is sent over a wired network, such as the Internet, to the server 206, as indicated by the solid line 214. The encoding of the request by the client 202 may be in accordance with WML, WMLScript, and so on. The request is received by the server 206. The content generators 216, in conjunction with the stored content 218, construct a response to the request that includes any requested content. The content generators may include applications or services, such as a Common Gateway Interface (CGI) script, that produce standard content formats in response to requests from the user agents 208. The WAE does not specify any standard content generators, however. The response is sent to the gateway 204 over the wired network, as indicated by the solid line 220. The encoders and decoders 212 of the gateway 204 encode the response, and the encoded response is then sent over the wireless network to the client 202, as indicated by the dotted line 222.

The encoders and decoders 212 of the wireless gateway 204 thus permit standard content encoding of content received in responses from the server 206. Standard content encoding is a set of well-defined content encoding that allows a WAE user agent, such as a browser program, to conveniently navigate the content. Standard content encoding includes compressed encoding for WML, bytecode encoding for WMLScript, standard image formats, multi-part container formats, and adopted business and calendar data formats. The user agents 208 of the client 202 may also be compatible with Wireless Telephony Applications (WTA), which are telephony-specific extensions for call and feature control mechanisms that provide end users with advanced mobile network services. The resulting WAE architecture of the system 200, which is based on and consistent with WAP, leverages the Internet and thin-client architectures, such as wireless phones and PDA devices, and provides an open, extensible framework for building wireless services.

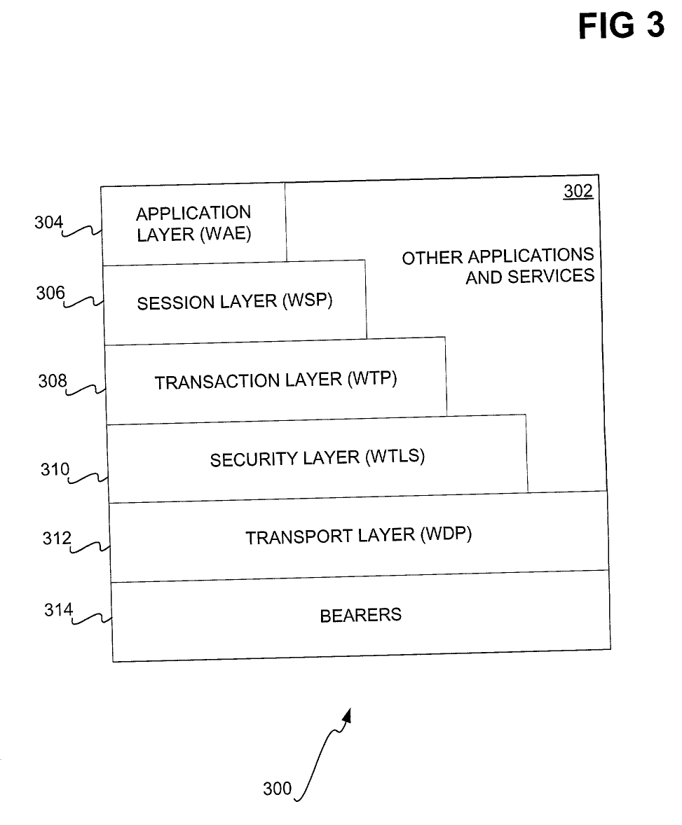

FIG. 3 shows a typical WAP stack architecture 300, in conjunction with which embodiments of the invention may be implemented. The architecture 300 includes a number of layers 304, 306, 308, 310, and 312, as well as bearers 314, and other applications and services 302. The application layer 304 is based on the WAE. It is a general-purpose application environment based on a combination of World Wide Web (WWW) and mobile telephony technologies. The primary objective of the WAE is to establish an interoperable environment that allows operators and service providers to build applications and services that can reach a wide variety of different wireless platforms in an efficient and useful manner. The WAE includes a micro-browser environment containing the following functionality: WML, WMLScript, WTA, and various content formats.

The session layer 306 is based on the Wireless Session Protocol (WSP). The WSP provides the application layer of WAP with a consistent interface for two session services. The first service is a connection-oriented service that operates above the transaction layer 308. The second service is a connectionless service that operates above a secure or non-secure datagram service, and thus above either the security layer 310 and/or the transport layer 312. The WSP includes services suitable for browsing applications, including HyperText Transport Protocol (HTTP) version 1.1 functionality and semantics, and long-lived session state session suspend and resume capabilities. The WSP also includes such services as a common facility for reliable and unreliable data pushes, and protocol feature negotiation. The WSP is desirably optimized for low-bandwidth bearer networks with relatively long latency.

The transaction layer 308 is based on the Wireless Transaction Protocol (WTP). The WTP runs on top of a datagram service, such as that provided by the transport layer 312, and provides a lightweight, transaction-oriented protocol that is suitable for implementation in thin clients, such as wireless phones and PDA devices. The WTP operates efficiently over secure and non-secure wireless datagram networks, and thus above either the security layer 310 and/or the transport layer 312. It provides unreliable and reliable transaction services, including unreliable one-way requests, reliable one-way requests, and reliable two-way request-reply transactions. The WTP further provides optional user-to-user reliability, where a WTP user triggers confirmation of each received message, and optional out-of-band data on acknowledgments. The WTP can provide Protocol Data Unit (PDU) concatenation and delayed acknowledgments to reduce the number of messages sent, as well as asynchronous transactions.

The security layer 310 is based on the Wireless Transport Layer Security (WTLS) protocol, which is itself based on the standard Transport Layer Security (TLS) protocol, formerly known as the Secure Sockets Layer (SSL). The WTLS protocol is intended for use with the WAP transport protocols of the transport layer 312, and is optimized for use over narrow-band communication channels. The WTLS protocol provides data integrity, privacy, authentication, and denial-of-service protection, and may be used for secure communication between terminals. Applications are able to selectively enable or disable WTLS features depending on their security requirements and the characteristics of the underlying network.

The transport layer 312 is based on the Wireless Datagram Protocol (WDP). The WDP layer operates above the data-capable services of the bearers 314 supported by various types of networks. As a general transport service, the WDP offers a consistent service to the upper-layer protocols of WAP, and communicates transparently over the bearers 314. Since the WDP protocol provides a common interface to the upper-layer protocols, the security layer 310, the transaction layer 308, the session layer 306, and the application layer 304 are able to function independently of the underlying wireless network provided by the bearers 314. The transport layer 312 is adapted to the specific features of the underlying bearers 314. By consistent maintenance of the transport layer 312 and its basic features, global interoperability can be achieved by using mediating gateways.

The bearers 314 are the basic services over which the WAP protocols of the layers 304, 306, 308, 310, and 312 are designed to operate. The bearers 314 can include short message services (SMS), circuit-switched data services, and packet data services. The bearers 314 offer differing levels of quality of service with respect to throughput, error rate, and delays. The WAP protocols are designed to compensate for or tolerate these varying levels of service. Specific examples of bearers 314 include Global System for Mobile Communication (GSM), Code Division Multiple Access (CDMA), Cellular Digital Packet Data (CDPD), and Interim Standard-136 (IS-136). Additional examples include Personal Handyphone System (PHS), Personal Digital Communications (PDC), and Integrated Digital Enhanced Network (IDEN).

The layering of the WAP architecture 300 enables other applications and services 302 to utilize the features of the WAP stack through a set of well-defined interfaces. External application may directly access the session layer 306, the transaction layer 308, the security layer 310, and the transport layer 312. This allows the WAP stack to be used for applications and services not currently specified by the WAP.

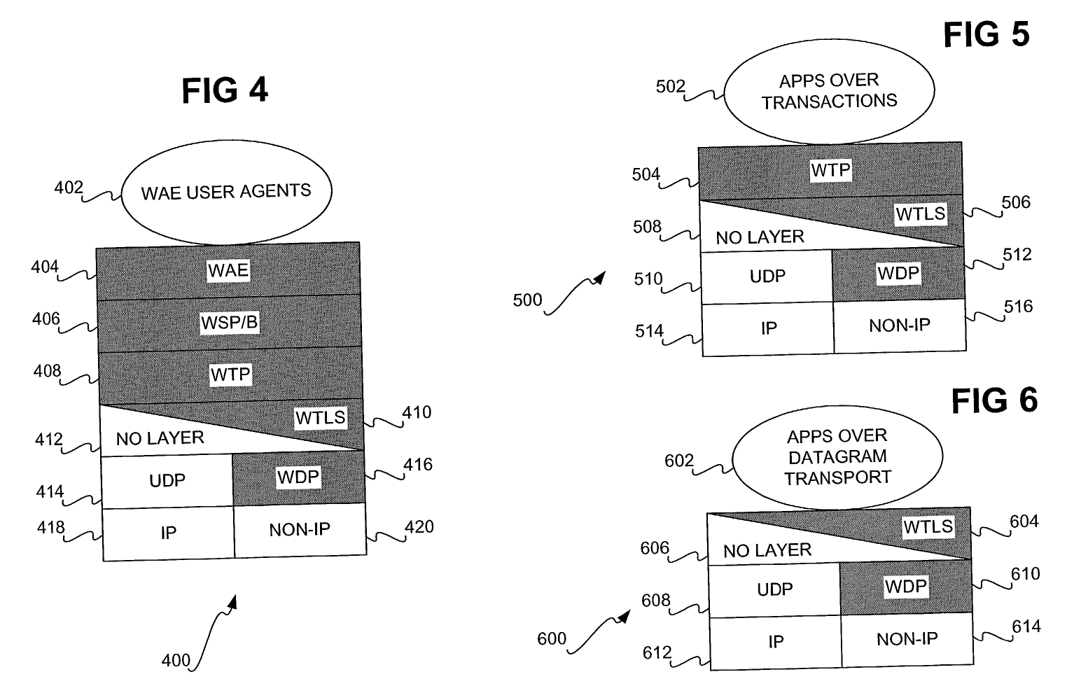

FIGS. 4, 5, and 6 show examples of WAP stacks in conjunction with which embodiments of the invention may be implemented. In FIG. 4, the stack 400 includes WAE user agents 402 running atop a complete portfolio of WAP technology. This includes the WAE layer 404, the WSP/Browser (WSP/B) layer 406, the WTP layer 408, the WTLS layer 410, and the WDP layer 416, which correspond to the layers 304, 306, 308, 310, and 312 of FIG. 3. The layers 404, 406, 408, 410, and 416 are shown as shaded to indicate that they are part of WAP technology. The non-layer 412, the User Datagram Protocol (UDP) layer 414, the Internet Protocol (IP) layer 416, and the non-IP layer 418 are examples of non-WAP technology that may be integrated with the WAP technology.

In FIG. 5, the stack 500 includes applications over transactions 502 that run atop of WAP layers intended for applications and services that require transaction services with or without security. Thus, there is only a WTP layer 504, a WTLS 506, and a WDP layer 512 insofar as the WAP technology is concerned, which is indicated as such as shaded in FIG. 5. The non-WAP technology includes the non-layer 508, the UDP layer 510, the IP layer 514, and the non-IP layer 516.

In FIG. 6, the stack 600 includes applications over datagram transport 602 that run atop of WAP layers intended for applications and services that only require datagram transport with or without security. Thus, the WAP technology, indicated as shaded, includes only a WTLS layer 604 and a WDP layer 610. The non-WAP technology includes the non-layer 606, the UDP layer 608, the IP layer 612, and the non-IP layer 614.

### Embodiment with Wireless Gateway and Firewall

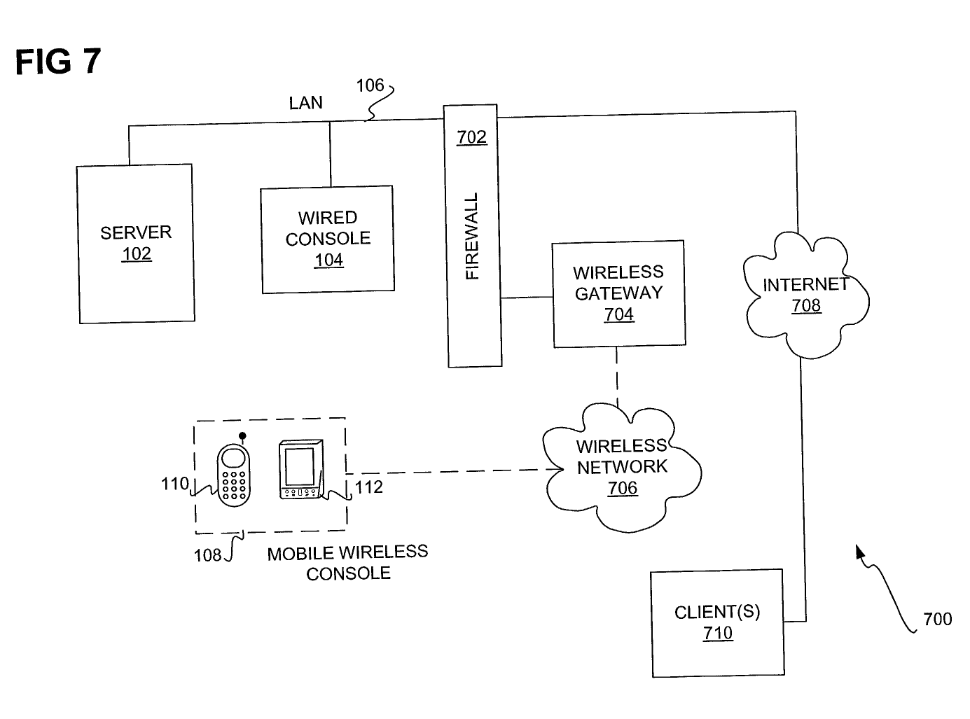

FIG. 7 shows a system 700 according to an embodiment of the invention in which there is a wireless gateway 704 and a firewall 702. The system 700 is consistent with the system 100 of FIG. 1 of the preferred embodiment of the invention. A gateway generally is a computer that performs protocol conversion between different types of networks or applications. In this case, the gateway 704 allows the mobile wireless consoles 108 to indirectly communicate with the server 102, where the former communicate over the wireless network 706, and the latter communicates over the local-area network (LAN) 106, which is a type of wired network. A firewall generally is a computer or software that keeps a network secure from intruders. In this case, the firewall 702 keeps the LAN 106, and thus the server 102 and the wired console 104, secure from intruders.

The server 102 is managed on-site through the wired console 104 over the LAN 106. The wired console 104 may be a client computer, for instance, on the LAN 106. The firewall 702 permits other computers and devices to access the server 102, but in a manner that prevents unauthorized tampering of the server 102. For example, the firewall 702 may be connected to the Internet 708, so that the client(s) 710 can access the server 102. Besides the Internet 708 and the LAN 106, other types of networks are also amenable to the system 700, including wide-area networks (WANs), extranets, intranets, and so on.

The wireless gateway 704 is shown in FIG. 7 as directly connected to the firewall 702. However, the gateway 704 may also be connected to the firewall 702 indirectly through the Internet 708. The wireless gateway 704 is the gateway between the LAN 106 and the wireless network 706, and thus between the server 102 and the mobile wireless consoles 108. The mobile wireless consoles 108 may include a wireless phone 110, such as a cellular phone, a personal-digital-assistant (PDA) device 112 having wireless communication capability, or another type of thin client.

Through the wireless gateway 704 and over the wireless network 706, the mobile wireless consoles 108 are able to manage the server 102 off-site, without the need for a full-fledged console, such as a desktop or a laptop computer. The wireless communication of the mobile wireless consoles 108 with the wireless gateway 704 is in accordance with an open, common, and non-proprietary protocol, such as the WAP. The mobile wireless consoles 108 are said to indirectly communicate wirelessly with the server 102, since they do not directly communicate with the server 102, but instead directly communicate with the wireless gateway 704.

The management activities that may be performed using the mobile wireless consoles 108 include out-of-band and in-band activities. Out-of-band activities involve pre-server boot activities, including initial hardware configuration setup that may specify boot strings, dump paths, and so on. The operating system (OS) of the server 102 is in a down state when out-of-band activities are performed. In-band activities involve activities when the OS of the server 102 is fully up and running. Any kind of regular system administration and performance monitoring functions can desirably be performed remotely through the mobile wireless consoles 108. As one example only, network users may be added, deleted, and modified through the mobile wireless consoles 108.

The mobile wireless consoles 108 are thin clients in that they have reduced processing capability, input capability, and display capability as compared to full-fledged consoles like desktop and laptop computers. Therefore, preferably, the management of the server 102 through the mobile wireless consoles 108 takes these reduced capabilities into account. For example, the information presented to the administrator on the mobile wireless consoles 108 may be restricted as compared to that which is presented on the wired console 104. That is, the entire display of information typically presented on the wired console 104 is not duplicated on the mobile wireless consoles 108. Furthermore, the controls available on the mobile wireless consoles 108 may be restricted to compensate for the reduced input capability of the consoles 108. Thus, menu-based and point-and-click controls may substitute for lengthy text input that may normally be accomplished on the wired console 104.

### Embodiment with Wireless Gateway and Without Firewall

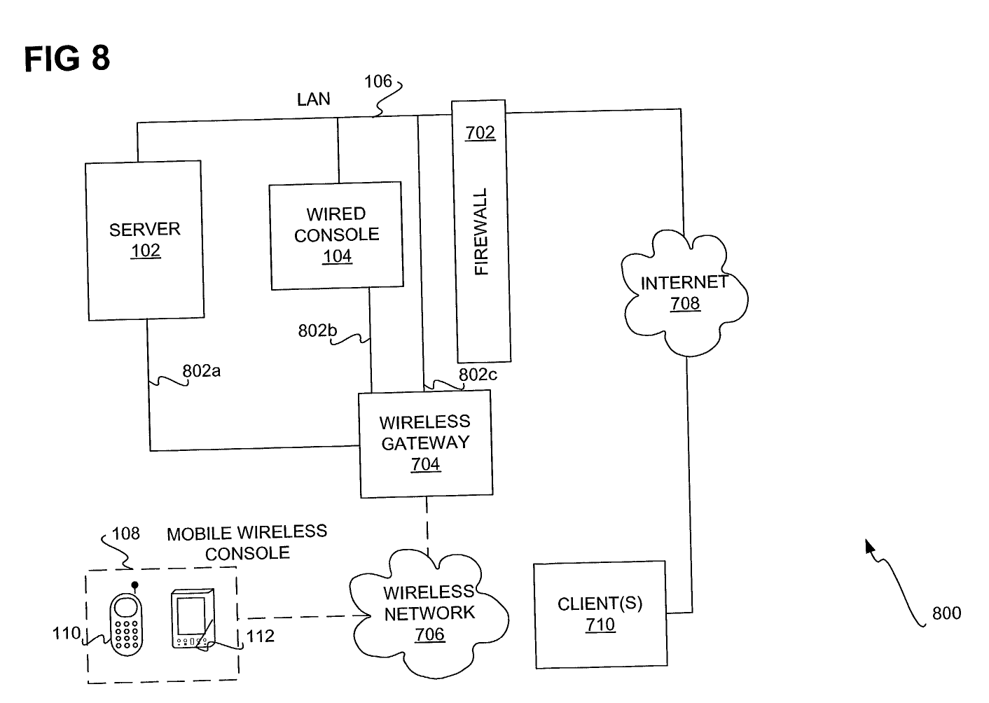

FIG. 8 shows a system 800 according to an embodiment of the invention in which the wireless gateway 704 communicates with the server 102 without going through the firewall 702. The system 800 is consistent with the system 100 of FIG. 1 of the preferred embodiment of the invention. As indicated by the lines 802a, 802b, and 802c, the wireless gateway 704 can be directly connected to the server 102, directly connected to the wired console 104, or connected to the LAN 106. Otherwise, the embodiment of FIG. 8 operates similarly as the embodiment of FIG. 7 does. The server 102 is managed on-site through the wired console 104 over the LAN 106. Client(s) 710 can access the server 102 through the Internet 708, by passing data through the firewall 702.

Through the wireless gateway 704 and over the wireless network 706, the mobile wireless consoles 108 are able to manage the server 102 off-site, without the need for a full-fledged console, such as a desktop or a laptop computer. The wireless communication of the mobile wireless consoles 108 with the wireless gateway 704 is in accordance with an open, common, and non-proprietary protocol, such as the WAP. The mobile wireless consoles 108 are said to indirectly communicate wirelessly with the server 102, since they do not directly communicate with the server 102, but instead directly communicate with the wireless gateway 704.

### Embodiment Without Wireless Gateway and Without Firewall

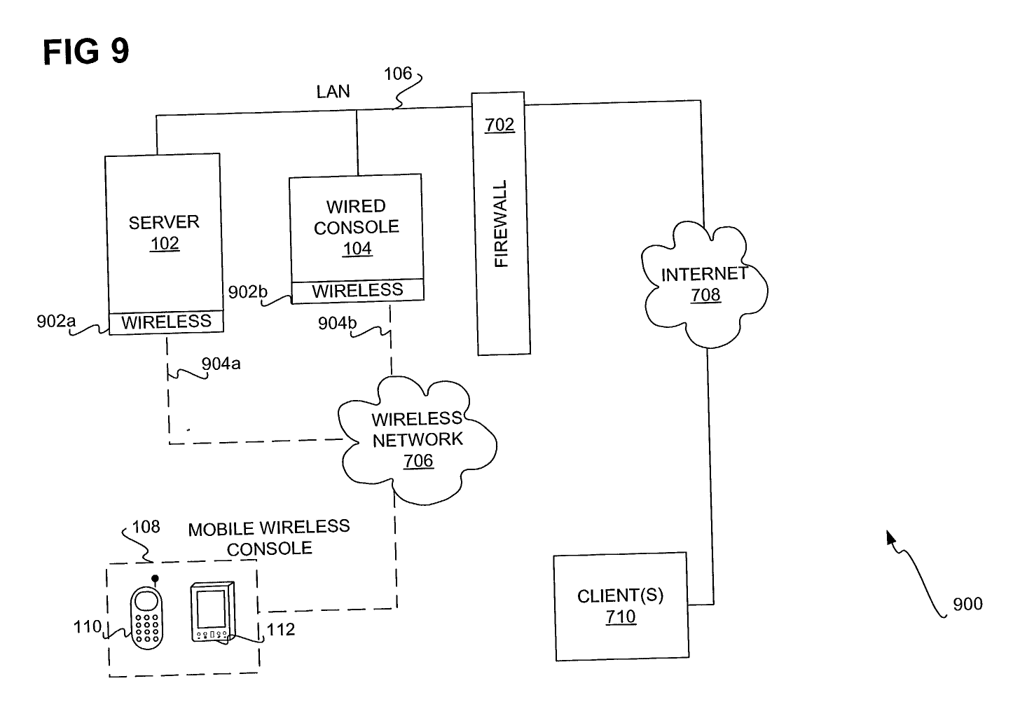

FIG. 9 shows a system 900 according to an embodiment of the invention in which there is no wireless gateway. Instead, the mobile wireless consoles 108 directly communicate with either the server 102 or the wired console 104, as indicated by the dotted lines 904a and 904b, respectively. In such instances, either the server 102 or the wired console 104 has a wireless component 902a or a wireless component 902b, respectively, to allow them to communicate over the wireless network 706. Other than this difference, the embodiment of FIG. 9 operates similarly as the embodiments of FIGS. 7 and 8 do. The server 102 is managed on-site through the wired console 104 over the LAN 106. Client(s) 710 can access the server 102 through the Internet 708, by passing data through the firewall 702. The system 900 is consistent with the system 100 of FIG. 1 of the preferred embodiment of the invention.

The mobile wireless consoles 108 are able to manage the server 102 off-site, over the wireless network 706, without the need for a full-fledged console, such as a desktop or a laptop computer. The wireless communication of the mobile wireless consoles 108 with the wireless component 902a or 902b of the server 102 or the wired console 104, respectively, is in accordance with an open, common, and non-proprietary protocol, such as the WAP. The mobile wireless consoles 108 are said to directly communicate wirelessly with the server 102 where the server 102 has a wireless component 902a that communicates over the wireless network 706. The mobile wireless consoles 108 are said to indirectly communicate wirelessly with the server 102 where the wired console 104 has a wireless component 902b that communicates over the wireless network 706.

### Method

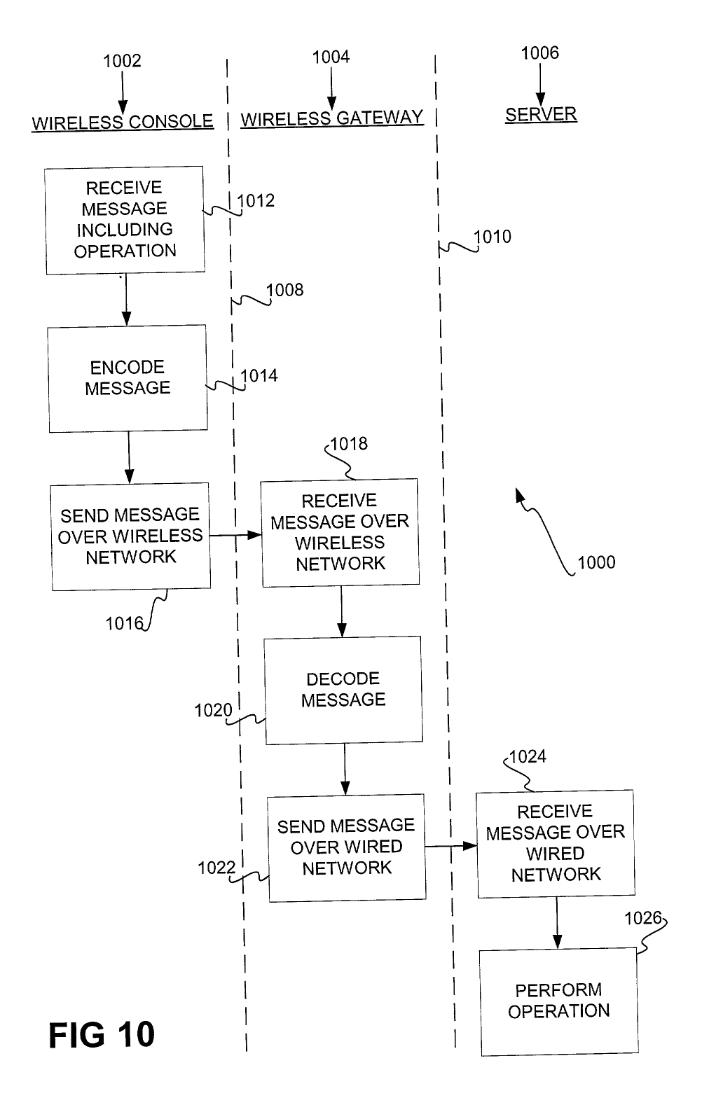

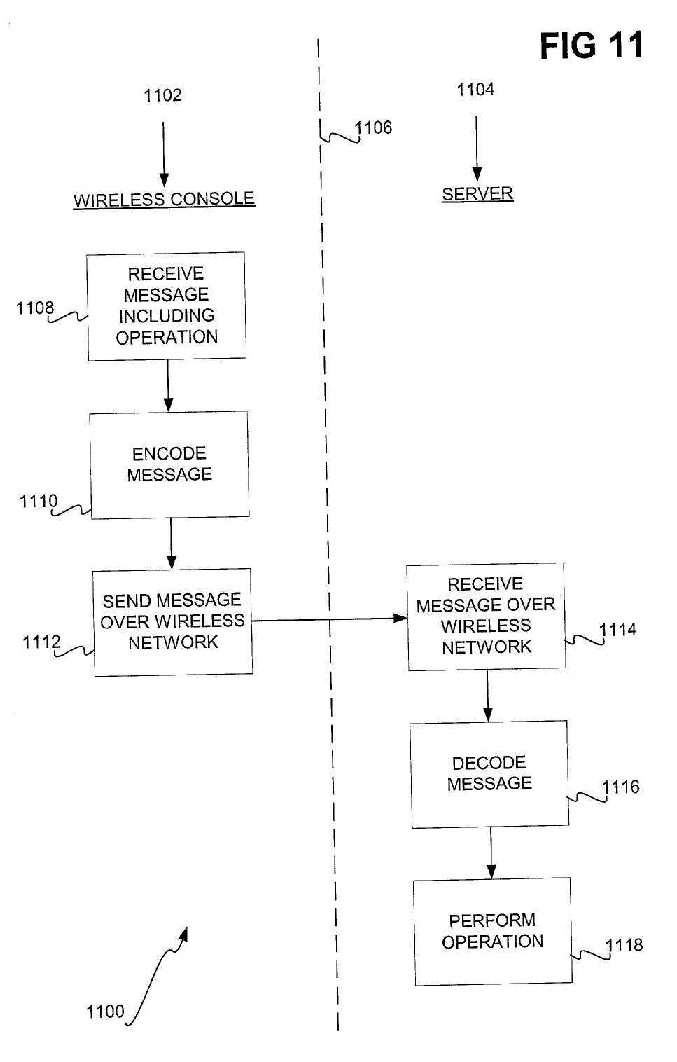

FIGS. 10 and 11 show methods 1000 and 1100, respectively, according to specific embodiments of the invention. The method 1000 can be implemented in conjunction with the systems 700 and 800 of FIGS. 7 and 8, respectively, whereas the method 1100 can be implemented in conjunction with the system 900 of FIG. 9. As with other embodiments of the invention, the methods 1000 and 1100 can also be implemented in conjunction with an article of manufacture having a computer-readable signal-bearing medium. The medium may be a recordable data storage medium, a modulated carrier signal, or another type of medium.

In FIG. 10, parts of the method 1000 are performed by the mobile wireless console, such as one of the consoles 108, the wireless gateway, such as the gateway 704, and the server, such as the server 102. This is indicated by the arrows 1002, 1004, and 1006 denoting columns separated by the dotted lines 1008 and 1010. The mobile wireless console first receives a message including a server management operation (1012). The mobile wireless console may receive the message by, for instance, the user indicating or otherwise entering the operation on the wireless console. The message is then encoded in accordance with an open, common, and non-proprietary protocol (1014), such as the WAP, and is sent over the wireless network to the wireless gateway (1016).

The wireless gateway receives the message from the mobile wireless console over the wireless network (1018). The gateway decodes the encoded message (1020), and sends the message as decoded over a wired network (1022), such as a LAN. The gateway may send the message through a firewall, such as in the case of the system 700 of FIG. 7, or not through a firewall, such as in the case of the system 800 of FIG. 8. The server receives the message from the wireless gateway over the wired network (1024), and performs the operation included in the message (1026). In this way, remote management of the server is performed by the mobile wireless console through the wireless gateway, where the console indirectly communicates wirelessly with the server.

In FIG. 11, parts of the method 1100 are performed by the mobile wireless console, such as one of the consoles 108, and the server, such as the server 102. This is indicated by the arrows 1102 and 1104 denoting columns separated by the dotted line 1106. The mobile wireless console again receives a message including a server management operation (1108). The console encodes the message in accordance with an open, common, and non-proprietary protocol (1110), such as the WAP, and sends the message over the wireless network to the server (1112), such as a wireless component thereof.

The server receives the message from the mobile wireless console over the wireless network (1114), and decodes the encoded message (1116), such as at a wireless component thereof. Alternatively, the console may send the message to a wireless component of a wired console, which decodes the encoded message and sends the message to the server over a wired network. The server finally performs the operation included in the message (1118). In this way, remote management of the server is performed by the mobile wireless console directly communicating wirelessly with the server, where the server receives the message over the wireless network directly from the mobile wireless console. Alternatively, remote management is performed by the mobile wireless console indirectly communicating wirelessly with the server, where the wired console receives the message over the wireless network from the mobile wireless console and sends it over the wired network to the server.

### Advantages over the Prior Art

Embodiments of the invention allow for advantages not found within the prior art. Remote server management is accomplished through a thin client, such as a wireless phone or PDA with mobile wireless communication capability, that can be carried by the administrator nearly anywhere. The administrator is not tethered to the LAN to perform server management on a wired console for the server. Furthermore, when the administrator is off-site, he or she is still able to perform server management even where there is no access to a full-fledged client, like a desktop or a laptop computer, connected to the Internet. Because the invention uses an open, common, and non-proprietary protocol, like the WAP, a wide variety of thin clients can be used, and the administrator is not limited to using a thin client that is compatible with a particular proprietary protocol.

### Alternative Embodiments

It will be appreciated that, although specific embodiments of the invention have been described herein for purposes of illustration, various modifications may be made without departing from the spirit and scope of the invention. For example, whereas the invention has been substantially described in relation to the Wireless Access Protocol (WAP), it is also amenable to implementation in conjunction with other open, common, and non-proprietary protocols. Such protocols include Internet Protocol (IP)-based mobile protocols, as well as other protocols. As another example, whereas the invention has been substantially described in relation to servers, it is also amenable to implementation in conjunction with other resources that can be managed, such as network platforms. Accordingly, the scope of protection of this invention is limited only by the following claims and their equivalents.

We claim:

1. A system comprising:
a resource; and,
one or more mobile wireless consoles, each mobile wireless console at least indirectly communicating wirelessly with the resource over a wireless network in accordance with an open, common, and non-proprietary protocol to manage the resource.

2. The system of claim 1, wherein the resource is one of a server and a network platform.

3. The system of claim 1, further comprising:
a firewall protecting the resource; and,
a wireless gateway outside the firewall, such that each mobile wireless console directly communicates wirelessly with the wireless gateway over the wireless network to indirectly communicate wirelessly with the resource, the wireless gateway communicating with the resource over a wired network through the firewall.

4. The system of claim 1, further comprising a wireless gateway, such that each mobile wireless console directly communicates wirelessly with the wireless gateway over the wireless network to indirectly communicate wirelessly with the resource, the wireless gateway communicating with the resource over a wired network.

5. The system of claim 1, wherein each mobile wireless console directly communicates wirelessly with the resource over the wireless network.

6. The system of claim 1, wherein at least one of the one or more mobile wireless consoles is each selected from the group of mobile wireless consoles essentially consisting of: a wireless phone, and a personal-digital-assistant (PDA) device having mobile wireless communication capability.

7. The system of claim 1, wherein each mobile wireless console at least indirectly communicates wirelessly to manage the resource to perform pre-boot management activities related to the resource.

8. The system of claim 1, wherein each mobile wireless console at least indirectly communicates wirelessly to manage the resource to perform in-band management activities related to the resource.

9. The system of claim 1, wherein the open, common, and non-proprietary protocol is a version of one of the Wireless Access Protocol (WAP) and an Internet Protocol (IP)-based mobile protocol.

10. The system of claim 1, wherein each mobile wireless console has a protocol stack in accordance with the open, common, and non-proprietary protocol.

11. A method comprising:
receiving a message including a resource management operation intended for a resource at a mobile wireless console;
encoding the message at the mobile wireless console in accordance with an open, common, and non-proprietary protocol; and,
sending the message as encoded from the mobile wireless console for ultimate delivery to the resource for performance of the resource management operation over a wireless network in accordance with the open, common, and non-proprietary protocol.

12. The method of claim 11, further comprising:
receiving the message as encoded at a wireless gateway from the mobile wireless console over the wireless network in accordance with the open, common, and non-proprietary protocol;
decoding the message at the wireless gateway in accordance with the open, common, and non-proprietary protocol;
sending the message as decoded from the wireless gateway for ultimate delivery to the resource for performance of the resource management operation over a wired network;
receiving the message at the resource from the wireless gateway over the wired network; and,
performing the resource management operation at the resource.

13. The method of claim 12, wherein sending the resource management operation as decoded from the wireless gateway over the wired network comprises sending the resource management operation as decoded from the wireless gateway through a firewall over the wired network.

14. The method of claim 11, further comprising:
receiving the resource management operation as encoded at the resource from the mobile wireless console over the wireless network in accordance with the open, common, and non-proprietary protocol;
decoding the resource management operation at the resource in accordance with the open, common, and non-proprietary protocol; and,
performing the resource management operation at the resource.

15. An article comprising:
a computer-readable signal-bearing medium; and,
means in the medium for managing a resource by at least indirectly communicating wirelessly with the resource over a wireless network in accordance with an open, common, and non-proprietary protocol.

16. The article of claim 15, wherein the means is for managing the resource by directly communicating wirelessly with a wireless gateway over the wireless network to indirectly communicate wirelessly with the resource, the wireless gateway communicating with the resource over a wired network through a firewall.

17. The article of claim 15, wherein the means is for managing the resource by directly communicating wirelessly with a wireless gateway over the wireless network to indirectly communicate wirelessly with the resource, the wireless gateway communicating with the resource over a wired network.

18. The article of claim 15, wherein the means is for managing the resource by directly communicating wirelessly with the resource over the wireless network.

19. The article of claim 15, wherein the means is for managing the resource to perform at least one of pre-boot management activities related to the resource and in-band management activities related to the resource.

20. The article of claim 15, wherein the medium is one of a recordable data storage medium and a modulated carrier signal.
